(19) United States
(12) Patent Application Publication
(10) Pub. No.: US 2023/0033176 A1
(43) Pub. Date: Feb. 2, 2023

(54) Coupler for an air/water syringe that prevents a quick release tip from rotating relative to the syringe's hand piece

(71) Applicant: Mikhail Y Kitsis, Seattle, WA (US)

(72) Inventor: Mikhail Y Kitsis, Seattle, WA (US)

(21) Appl. No.: 17/815,695

(22) Filed: Jul. 28, 2022

Related U.S. Application Data
(60) Provisional application No. 63/227,049, filed on Jul. 29, 2021.

(51) Int. Cl. A61C 17/02

(52) U.S. Cl. CPC A61C 17/0202; A61C 17/0217

(57) ABSTRACT

An air/water dental syringe includes a hand-piece, a coupler, and a tip that is releasably coupled with the hand-piece. The coupler includes a collar that releasably engages the hand-piece, and a cap that releasably engages the collar. The cap includes a body having a first end, a second end, and a cavity located between the first end and the second end, such that when the cap engages the collar, the collar extends into the cavity through the first end. The cap also includes a receiver located at the second end of the body. The tip includes a tube, and a post mounted to the tube. The tube has a first end that extends extend through the cap and the collar of the coupler and releasably engages the hand-piece, and a second end operable to dispense air/water from the tip. The post extends away from the first end of the tube and is sized and configured to extend into the cap's receiver to prevent the tip from rotating relative to the hand-piece.

### CROSS-REFERENCE TO RELATED APPLICATIONS AND INCORPORATION BY REFERENCE

This application claims priority from U.S. Provisional Patent Application 63/227,049 filed 29 Jul. 2021 and titled “Coupler For An Air/Water Syringe That Prevents The Tip From Rotating Relative To The Syringe's Head And Handle”. This application also incorporates by this reference the entirety of this U.S. Provisional Patent Application.

### BACKGROUND

Dentists and dental assistants often use air and/or water to clean and dry surfaces of teeth as well as gums and other anatomy of a patient's mouth to remove debris and increase visibility. The tool that dentists and dental assistants typically use to do this is an air/water dental syringe that directs air and/or water to the specific site within a patient's mouth via a tip that is similar to a cannula. To allow the dentist and dental assistant to quickly get the air/water dental syringe ready for the next patient, the tip and/or tips used are often coupled with the syringe's hand-piece via a quick-release mechanism in which an end of the tip is simply pushed into a receptacle of the hand-piece until it clicks into position, and then to remove the tip, the tip is simply pulled out of the receptacle.

Unfortunately, such quick-release mechanisms typically allow the tip to rotate relative to the hand-piece while the tip is coupled with the hand-piece. This causes problems for the dentist and dental assistant using the air/water dental syringe because working in a patient's mouth also often requires retraction of the patient's tongue and/or cheek to gain access to a desired tooth. Because the quick-release mechanism allows the tip of the air/water dental syringe to rotate, the dentist and dental assistant are not able to safely use the tip as a retractor in addition to delivering air/water to the desired tooth. Thus, the dentist has to have an assistant hold a retractor while the dentist uses the dental syringe and another tool to work on the desired tooth.

Thus, there is a need for a quick-release tip that does not rotate relative to the hand-piece of an air/water dental syringe while the tip is coupled with the hand-piece.

### SUMMARY

In one aspect of the invention, a coupler, for preventing a quick-release tip for an air/water dental syringe from rotating when the tip is coupled with a hand-piece of the syringe, includes a cap that is operable to engage a collar and through which a tip extends when the tip is coupled with a hand-piece of an air/water dental syringe. The cap includes a body and a receiver. The body has a first end, a second end, and a cavity located between the first end and the second end. When the cap engages the collar, the collar extends into the cavity through the first end. The receiver is located at the second end of the body and is operable to receive a post of the tip when the tip is coupled with a hand-piece of an air/water dental syringe.

In another aspect of the invention, a quick-release tip for an air/water dental syringe, includes a tube having a first end and a second end, and a post mounted to the tube. The tube's first end extends through a cap of a coupler and engages a hand-piece of an air/water syringe, when the tip is coupled with the hand-piece. The tube's second end is operable to dispense air/water from the tip when the tip is coupled with the hand-piece. The post is mounted to the tube's first end and extends from the tube. The post is also operable to extend into a receiver of the cap when the tip is coupled with the hand-piece.

With the tip's post extending into the cap's receiver when the tip is coupled with a hand-piece of an air/water dental syringe, the cap's receiver holds the tip's post while the tip is coupled with the hand-piece. In this manner, the cap prevents the tip from rotating relative to the hand-piece while the tip is coupled with the hand-piece. Thus, a dentist and/or dental assistant may us the air/water syringe to direct air and/or water at a desired tooth within a patient's mouth, and also use the tip of the syringe to retract the patient's cheek and/or tongue while accessing the tooth. This, in turn, allows the dentist and/or dental assistant to free-up a hand for use with another tool, such as a pick, scraper, or mirror.

In yet another aspect of the invention, an air/water dental syringe includes a hand-piece, a coupler, and a tip that is releasably coupled with the hand-piece. The coupler includes a collar that releasably engages the hand-piece, and a cap that releasably engages the collar. The cap includes a body having a first end, a second end, and a cavity located between the first end and the second end, such that when the cap engages the collar, the collar extends into the cavity through the first end. The cap also includes a receiver located at the second end of the body. The tip includes a tube, and a post mounted to the tube. The tube has a first end that extends extend through the cap and the collar of the coupler and releasably engages the hand-piece, and a second end operable to dispense air/water from the tip. The post extends away from the first end of the tube and is sized and configured to extend into the cap's receiver to prevent the tip from rotating relative to the hand-piece.

In yet another aspect of the invention, a method for preventing a quick-release tip for an air/water dental syringe from rotating relative to the syringe's hand-piece, includes: 1) engaging a collar with a hand-piece of an air/water dental syringe; 2) inserting an end of the collar into a cavity of a cap; 3) engaging the end of the collar with the cap; 4) inserting an end of a tip through the cap and the collar; 5) engaging the end of the tip with the hand-piece; and 6) inserting a post of the tip into a receiver of the cap to prevent the tip from rotating relative to the cap.

### BRIEF DESCRIPTION OF THE DRAWINGS

FIG. 1A shows an exploded view of an air/water dental syringe, according to an embodiment of the invention.

FIG. 1B shows a detail of a coupler of the air/water dental syringe shown in FIG. 1A, according to an embodiment of the invention.

FIG. 2 shows a tip coupled with a hand-piece of the air/water dental syringe, according to an embodiment of the invention.

Each of FIGS. 3A, 3B, and 3C shows a cap of the coupler shown in FIGS. 1A—2, according to an embodiment of the invention. FIG. 3A shows a perspective view of the cap. FIG. 3B shows a plan view of the cap. And FIG. 3C shows a cross-sectional view of the cap.

FIG. 4 shows a tip of the air/water dental syringe shown in FIGS. 1A and 1B, according to an embodiment of the invention.

### DETAILED DESCRIPTION

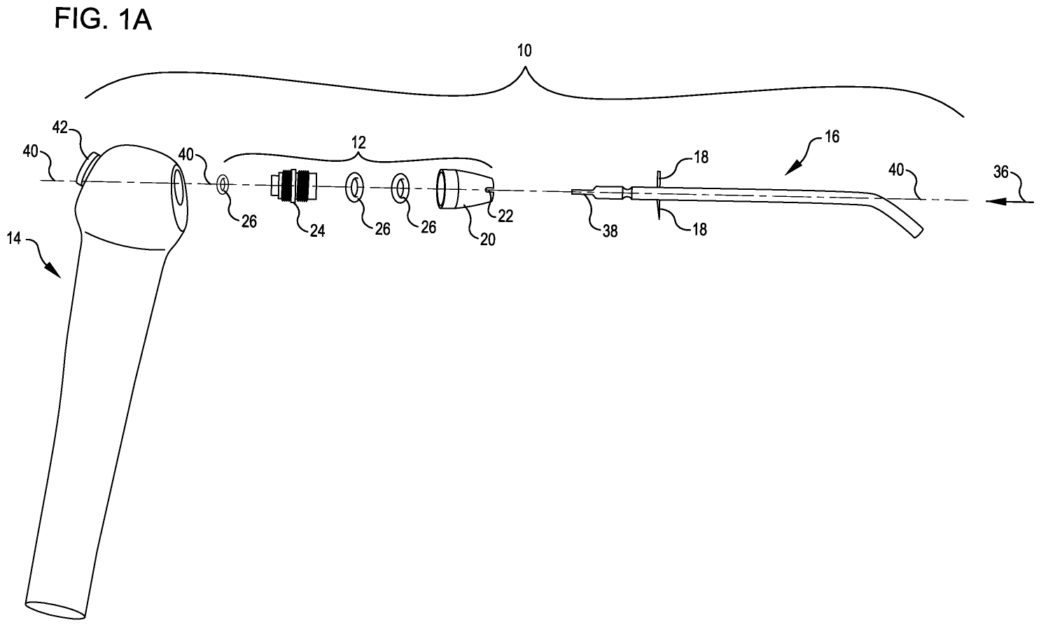

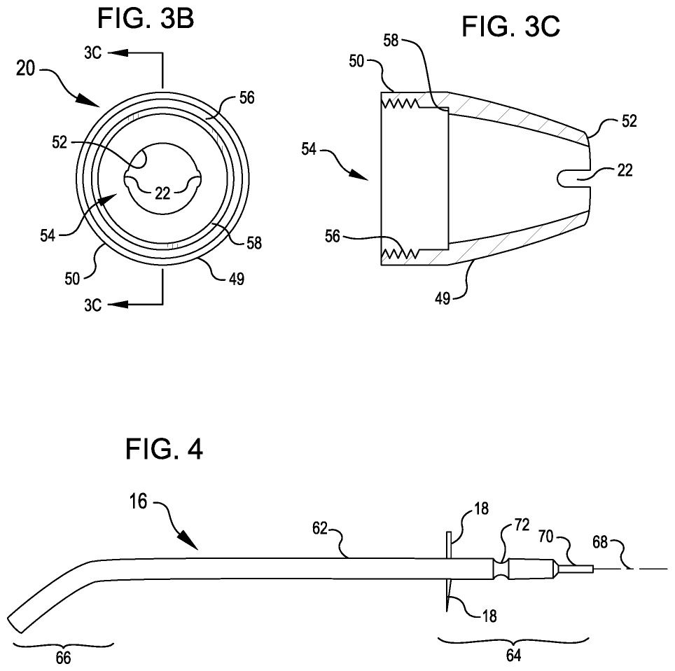

FIG. 1A shows an exploded view of an air/water dental syringe 10, and FIG. 1B shows a detail of a coupler 12 of the air/water dental syringe 10, each according to an embodiment of the invention. The syringe 10 includes a hand-piece 14 to grip and manipulate the syringe 10 for use, a tip 16 to direct fluid (here air and/or water) to a desired tooth or other anatomical feature inside a patient's mouth, and the coupler 12 to releasably couple the tip 16 with the hand-piece 14 and allow the tip 16 to be quickly removed from the hand-piece 14. The tip 16 (discussed in greater detail in conjunction with FIG. 4) includes a post 18 (here two); and the coupler 12 includes a cap 20 (discussed in greater detail in conjunction with FIGS. 3A, 3B, and 3C) that has a receiver 22. When the coupler 12 couples the tip 16 with the hand-piece 14, the tip's post 18 extends into the cap's receiver 22 and is held by the receiver 22 to prevent the tube's post 18 from rotating relative to the cap 20.

With the tip's post 18 extending into the cap's receiver 22 when the coupler 12 couples the tip 16 with the hand-piece 14 of the air/water dental syringe 10, the cap 20 prevents the tip 16 from rotating relative to the hand-piece 14 while the tip 16 is coupled with the hand-piece 14. Thus, a dentist and/or dental assistant may us the air/water syringe 10 to direct air and/or water at a desired tooth or other anatomical feature inside a patient's mouth, and may also use the tip 16 of the syringe 10 to retract the patient's cheek, lip, and/or tongue while accessing the tooth or other anatomical feature. This, in turn, allows the dentist and/or dental assistant to free-up a hand for use with another tool, such as a pick, scraper, or mirror.

In this and other embodiments, the coupler 12 also includes a collar 24, and three O-rings 26. The collar 24 includes a first end 28 configured to engage the hand-piece 14, and a second end 30 configured to engage the cap 20. More specifically, when the coupler 12 couples the tip 16 with the hand-piece 14, the threads 32 located on the collar's first end 28 threadingly engage corresponding threads (not shown) in the hand-piece 14 to secure the collar 24 to the hand-piece 14, and the threads 34 located on the collar's second end 30 threadingly engage corresponding threads (shown in FIGS. 3B and 3C) in the cap 20 to secure the cap 20 to the collar 24, and thus the hand-piece 14. The O-rings 26 are sized and configured to seal the tip 16 with the hand-piece 14 and to releasably hold the tip 16 with the coupler 12, and thus the hand-piece 14. In this manner, the tip 16 may be quickly removed from the hand-piece 14 and may be replaced with a tip 16 that is larger, smaller, longer, or shorter than the current tip 16, or that has a shape or configuration that is different than the current tip 16.

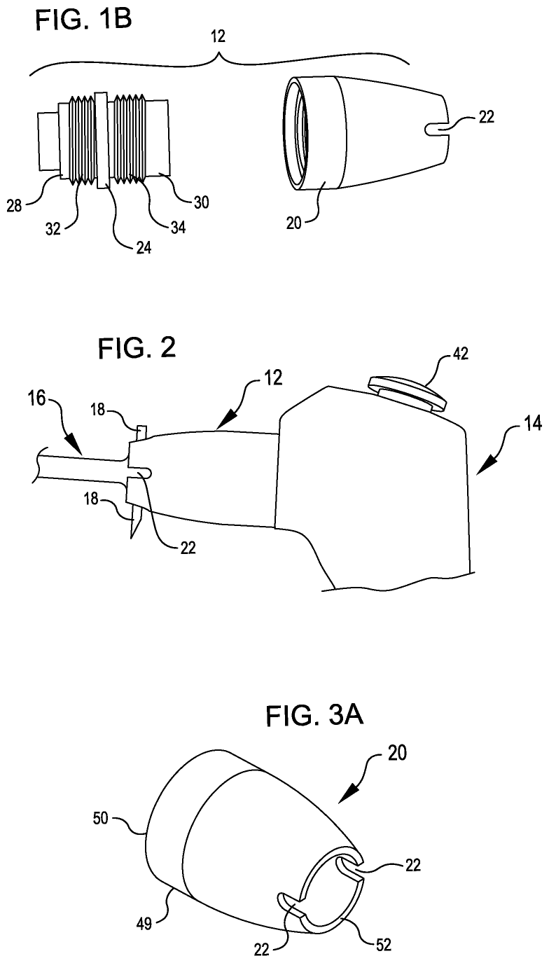

The tip 16 may be releasably coupled with the hand-piece 14 in any desired manner that allows the tip 16 to be quickly released from the hand-piece 14 when desired, yet held to the hand-piece 14 when the tip 16 is used to retract an anatomical feature and/or deliver air and/or water where desired. For example, in this and other embodiments, to couple the tip 16 with the hand-piece 14, one positions one of the O-rings 26 between the hand-piece 14 and the collar 24, and then engages the first end 28 of the collar 24 with the hand-piece 14. Next, one positions the other O-rings between the collar 24 and the cap 20, and then engages the second end 30 of the collar 24 with the cap 20. Next, one moves the tip 16 in the direction indicated by the arrow 36 to insert the end 38 of the tip 16 through the cap 20, through the O-rings 26, through the collar 24, through the third O-ring 26 and finally into the hand-piece 14. When moving the tip's end 38 into the hand-piece 14, the tip 16 may be clocked or rotated about the axis 40 to align the tip's post 16 with a receiver 22 of the cap 20. Once these are aligned, the tip's end 38 may then be inserted the remainder of the way into the hand-piece 14. FIG. 2 shows the tip 16 coupled with the hand-piece 14 by the coupler 12 according to this embodiment. To remove the tip 16 from the hand-piece 14, one pulls the tip 16 in the direction opposite to the direction indicated by the arrow 36.

Still referring to FIGS. 1A and 1B, the hand-piece 14 may be configured as desired. For example, in this and other embodiments the hand-piece 14 includes two separate conduits (not shown) that are located inside the hand-piece 14 and deliver two different fluids (here air and water) to the tip 16. To control which fluid is delivered to the tip 16 to then be directed to a patient's anatomical feature, the hand-piece includes a valve that has two inputs 42 (only one shown).

Each of FIGS. 3A, 3B, and 3C shows a cap 20 of the coupler 12 shown in FIGS. 1A-2, according to an embodiment of the invention. FIG. 3A shows a perspective view of the cap 20. FIG. 3B shows a plan view of the cap 20. And FIG. 3C shows a cross-sectional view of the cap 20. The cap 20 confines the O-rings 26 that are positioned between the collar 24 and the cap 20, so that the O-rings 26 can releasably hold the tip 16 when the tip 16 is inserted through the coupler 12. The cap 20 also holds the tip 16 and prevents the tip 16 from rotating relative to the hand-piece 14 when the tip 16 is coupled with the hand-piece 14.

In this and other embodiments, the cap 20 includes a body 49 that has a first end 50, a second end 52, a cavity 54, and the receiver 22. The body 49 may have any desired shape. For example, in this and other embodiments the body 49 is conical. That is, the body 49 is cylindrical in shape and has a diameter at the first end 50 that is longer than the diameter at the second end 52. The cavity 54 is located between the first end 50 and the second end 52, and is sized and configured to receive and engage the second end 30 (FIG. 1B) of the collar 24 (FIGS. 1A-2). More specifically, the cavity 54 includes a thread 56 that threadingly engages the thread 34 (FIG. 1B) of the collar 24. The cavity also includes a seat 58 that one of the O-rings 26 contacts when the cap 20 engages the collar 24, to position the O-ring between the cap 20 and the collar 24 to hold the tip 16.

The receiver 22 may be located anywhere desired on the cap's second end 52, and may be sized and configured as desired. For example, in this and other embodiments the receiver 22 includes two slots, each of which is located 180 degrees away from the other. In this configuration, the tip 16 may be positioned into different positions relative to the hand-piece 14, which may facilitate one's use of the dental syringe 10 in either one's left or one's right hand. In addition, this configuration facilitates the use of the dental syringe 10 in either the right half of a patient's mouth or the left half. In the embodiment shown in FIG. 2, the receiver 22 of the cap 20 includes four slots, each of which is located 180 degrees away from one of the three remaining slots, and 90 degrees away from the two remaining slots. In this configuration, one has even more positions available to place the tip 16 in when using the tip 16 as a retractor and to deliver air and/or water into a patient's mouth.

Other embodiments are possible. For example, the cap 20 may include a single slot, three slots, or more than four slots to allow one to position the tip 16 in more than two different positions. For another example, the receiver 22 may include a hole that the tip's post 18 extends into. In such embodiments, the post could move toward and away from the axis 40 (FIG. 1A) to allow the tip 16 to be inserted through the cap 20, collar 24, and into the hand-piece 14. With the hole receiving the tip's post 18, the cap's body 49 can also help prevent the tip 16 from being inadvertently separated from the hand-piece 14.

FIG. 4 shows a tip 16 of the air/water dental syringe 10 shown in FIGS. 1A-2, according to an embodiment of the invention. One may use the tip 16 to direct fluid to a desired tooth or other anatomical feature inside a patient's mouth when the tip 16 is coupled with the hand-piece 14 (FIG. 1A).

The tip 16 may be configured as desired. For example, in this and other embodiments the tip 16 includes a tube 62 that has a first end 64 that extends through the coupler 12 (FIGS. 1A-2) and into the hand-piece 14 when the tip 16 is releasably coupled with the hand-piece 14, and a second end 66 through which water and/or air flows when the water and/or air is directed to a desired tooth or other anatomical feature inside a patient's mouth. The first end 64 includes a longitudinal axis 68, and the post 18 (here two) that extends into the cap's receiver 22 to prevent the tip 16 from rotating about the longitudinal axis 68, thus preventing the tip from rotating relative to the cap 20 and coupler 12. The first end 64 also includes an extension 70 that is narrower than the remainder of the tube 62 and that is held by the hand-piece 14 and the O-ring 26 positioned in the hand-piece 14 (FIG. 1A), and a groove 72 that receives and holds one of the O-rings 26 positioned between the cap 20 and the collar 24 (also FIG. 1A). The second end 66 is configured such that the air and/or water directed by the second end 66 is directed at an angle that is oblique to the axis 68. In other embodiments, the second end 66 may not be bent or curved relative to the remainder of the tube 62. In still other embodiments the second end 66 may be bent or curved more than what is shown in FIG. 4.

The tip 16 may also include any desired number of posts 18, positioned on the tube's first end 64 as desired. For example, in this and other embodiments the tip 16 includes two posts 18 each located 180 degrees apart from the other and each extending in diametrically opposite directions away from the longitudinal axis 68. In other embodiments, the tip 16 may include a single post 18. In still other embodiments, the tip 16 may include more than two posts, each equidistant from the posts 18 adjacent it. In yet other embodiments, the tip 16 may include more than two posts 18 that are not equidistant from the other posts 18.

Still referring to FIG. 4, each post 18 may be sized and configured as desired to allow the cap's receiver 22 to easily hold the post 18 and prevent the post 18 from rotating about the axis 68. For example, in this and other embodiments the post 18 extends away from the tube's first end 64 in a direction that is substantially perpendicular to the longitudinal axis 68. In addition, the post 18 has a length such that the post 18 extends through the cap's receiver 22 when the coupler 12 releasably couples the tip 16 to the hand-piece 15. In other embodiments, the post 18 may be sized and configured to extend into the cap's receiver 22 but not through the cap's receiver 22, when the coupler releasably couples the tip 16 with the hand-piece 14. In still other embodiments, the post 18 may extend away from the tube's first end 64 in a direction that is not substantially perpendicular to the longitudinal axis 68.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A coupler for preventing a quick-release tip for an air/water dental syringe from rotating when the tip is coupled with a hand-piece of the syringe, the coupler comprising:
a cap that is operable to engage a collar and through which a tip extends when the tip is coupled with a hand-piece of an air/water dental syringe, wherein the cap includes:
a body having a first end, a second end, and a cavity located between the first end and the second end, wherein when the cap engages the collar, the collar extends into the cavity through the first end, and
a receiver located at the second end of the body and operable to receive a post of the tip when the tip is coupled with a hand-piece of an air/water dental syringe.

2. The coupler of claim 1 wherein the cap includes threads inside the cavity that are operable to engage the collar.

3. The coupler of claim 1 wherein the body is conical and the first end has a larger diameter than the second end.

4. The coupler of claim 1 wherein the cap includes a seat inside the cavity that is operable to contact a seal when the cap engages the collar.

5. The coupler of claim 1 wherein the receiver includes a slot sized to receive the tip's post when the tip is coupled with the hand-piece.

6. The coupler of claim 1 wherein the receiver includes at least two slots, each sized to receive the tip's post when the tip is coupled with the hand-piece.

7. The coupler of claim 1 wherein the receiver includes at least two slots, two of which are located 180 degrees away from each other, each sized to receive the tip's post when the tip is coupled with the hand-piece.

8. The coupler of claim 1 wherein the receiver includes four slots, each of which is located 180 degrees away from one of the remaining three slots and 90 degrees away from the other two slots, and each of which is sized to receive the tip's post when the tip is coupled with the hand-piece.

9. A quick-release tip for an air/water dental syringe, the tip comprising:
a tube having a first end operable to extend through a cap of a coupler and engage a hand-piece of an air/water syringe, when the tip is coupled with the hand-piece, and a second end operable to dispense air/water from the tip when the tip is coupled with the hand-piece; and
a post mounted to the first end of the tube and extending from the tube, the post operable to extend into a receiver of the cap when the tip is coupled with the hand-piece.

10. The tip of claim 9 wherein the first end of the tube includes a longitudinal axis and the post extends substantially perpendicular to the longitudinal axis.

11. The tip of claim 9 wherein the post is configured to extend through the cap's receiver when the tip is coupled with the hand-piece.

12. The tip of claim 9 wherein the tip includes at least two posts each sized to extend into a respective receiver of the cap when the tip is coupled with the hand-piece.

13. The tip of claim 9 wherein the tip includes at two posts each of which is located 180 degrees away from the other one and each of which is sized to extend into a respective receiver of the cap when the tip is coupled with the hand-piece.

14. An air/water dental syringe comprising:
a hand-piece;
a coupler that comprises:
a collar that releasably engages the hand-piece, and
a cap that releasably engages the collar, and comprises:
a body having a first end, a second end, and a cavity located between the first end and the second end, wherein when the cap engages the collar, the collar extends into the cavity through the first end, and
a receiver located at the second end of the body; and
a tip releasably coupled with the hand-piece, the tip comprising:
a tube having a first end that extends extend through the cap and the collar of the coupler and releasably engages the hand-piece, and a second end operable to dispense air/water from the tip; and
a post mounted to and extending away from the first end of the tube, the post sized and configured to extend into the cap's receiver to prevent the tip from rotating relative to the hand-piece.

15. The air/water dental syringe of claim 14 wherein the tip may be quickly released from the hand-piece by pulling the tip away from the hand-piece.

16. A method for preventing a quick-release tip for an air/water dental syringe from rotating relative to the syringe's hand-piece, the method comprising:
engaging a collar with a hand-piece of an air/water dental syringe;
inserting an end of the collar into a cavity of a cap;
engaging the end of the collar with the cap;
inserting an end of a tip through the cap and the collar;
engaging the end of the tip with the hand-piece; and
inserting a post of the tip into a receiver of the cap to prevent the tip from rotating relative to the cap.

17. The method of claim 16 wherein engaging the collar with the hand-piece includes a thread in a first end of the collar threadingly engaging a corresponding thread in the handpiece.

18. The method of claim 16 wherein engaging the end of the collar with the cap includes a thread in a second end of the collar threadingly engaging a corresponding thread in a cavity of the cap.

19. The method of claim 16 wherein inserting the end of the tip through the cap and the collar includes pushing the end of the tip through the cap and collar without rotating the tip.

20. The method of claim 16 wherein engaging the end of the tip with the hand-piece includes inserting a portion of an O-ring disposed in the hand-piece into a groove in the tip's tube and contacting the tube.

21. The method of claim 16 wherein inserting the post of the tip into the receiver of the cap includes inserting a first post of the tip into a first slot of the cap, and a second post into a second slot of the cap.
